(19) United States
(12) Patent Application Publication
(10) Pub. No.: US 2006/0214597 A1
(43) Pub. Date: Sep. 28, 2006

(54) Method of correcting amount of light emitted from an exposure head and exposure apparatus

(75) Inventor: Yasuhiro Seto, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/368,390

(22) Filed: Mar. 7, 2006

(30) Foreign Application Priority Data
Mar. 7, 2005 (JP) 062069/2005

(51) Int. Cl. G09G 3/10

(52) U.S. Cl. 315/169.3

(57) ABSTRACT

An exposure head includes a linear light emitting element array, in which light emitting elements are aligned, and a lens array, in which lenses are aligned. The light emitting elements are caused to emit light uniformly, based on a common command signal. The amount of light emitted through the lens array is measured at a measuring pitch less than or equal to the arrangement pitch of the light emitting elements, across the length of the array. Correction coefficients for correcting the amount of light emitted from each light emitting element to shorten the period of fluctuation in the amount of light, which is a period of the lens arrangement pitch within the lens array, are calculated, based on the measured amount of light. During exposure, the amounts of light emitted from the light emitting elements, which are controlled based on image signals, are corrected based on the correction coefficients.

### BACKGROUND OF THE INVENTION

1. Field of the Invention

The present invention relates to a method for correcting the amount of light emitted from an exposure head, which is equipped with a linear light emitting element array constituted by a plurality of light emitting elements aligned in a single row.

The present invention also relates to an exposure apparatus that implements the method for correcting the amount of light emitted from an exposure head.

2. Description of the Related Art

U.S. Pat. No. 5,592,205 and Japanese Unexamined Patent Publication No. 2000-013571 disclose apparatuses that expose photosensitive materials, employing exposure heads comprising linear light emitting element arrays constituted by a plurality of light emitting elements aligned in a single row. Generally in this type of exposure head, the linear light emitting element array is combined with a lens array. Light, which is focused by the lens array, is irradiated onto a photosensitive material, which is the target of exposure. The lens array is constituted by a plurality of ×1 magnification lenses which are aligned parallel to the row of light emitting elements, to focus the light emitted by each of the light emitting elements.

An exposure apparatus that employs this type of exposure head further comprises a sub scanning means, for holding the photosensitive material at a position onto which light emitted from the exposure head is irradiated, and for moving the photosensitive material and the exposure head relative to each other in a sub scanning direction substantially perpendicular to the arrangement direction of the light emitting elements within the linear light emitting element array (main scanning direction).

There are cases in which individual light emitting elements, for example, organic EL light emitting elements that constitute the linear light emitting element array, have different light emitting properties. In these cases, the amounts of light emitted by each light emitting element may differ, even if the same light emission command signal is issued. Therefore, when an image that includes a portion having the same density or the same hue along the main scanning direction is to be exposed by the exposure apparatus, steps in density or hue are generated. These steps extend along the sub scanning direction accompanying scanning in the sub scanning direction, and appear as striped irregularities in the exposed image.

There is a known method for resolving fluctuations in the amounts of light emitted from linear light emitting element arrays that appear in the longitudinal direction of the arrays. In this method, each light emitting element of an array is caused to emit light uniformly, based on a common light emission command signal. The amounts of light emitted from each light emitting element is measured at this time, to derive the characteristics of fluctuation in the amounts of light emitted. During actual use of the linear light emitting element array, the amounts of light emitted by each of the light emitting elements are corrected to resolve the fluctuation characteristics.

When executing such a method for correcting the emitted amounts of light, it is necessary to accurately measure the amount of light emitted by each light emitting element when the light emitting elements are uniformly caused to emit light. However, because the light emitting elements are provided in extreme close proximities of each other the amount of light emitted from a light emitting element may be inaccurately measured, due to influence by light emitted from an adjacent element. FIG. 1 illustrates an example of the distribution of amounts of light in the longitudinal direction of a linear light emitting element array comprising twelve light emitting elements, measured at the focal plane of a lens array. As illustrated here, the fringe of the amount of light emitted from a first element may extend to the center of light emission of a second element adjacent thereto. In this case, if an attempt is made to measure the amount of light emitted by the second element at its center of light emission, the measured value will be higher than the actual value, due to influence by the light emission of the first element. This tendency becomes more conspicuous as the arrangement of light emitting elements becomes denser, and as the arrangement pitch approaches the minimum beam diameter that the lenses can focus to.

Japanese Patent No. 3374687 discloses a method for accurately measuring the amount of light emitted by each light emitting element, without being influenced by light emitted from adjacent elements. In this method, a light detecting sensor, having its light receiving width limited by a slit, is moved with respect to a great number of light emitting elements, which are arranged in a main scanning direction, in the main scanning direction. At this time, the light emitting elements are caused to emit light intermittently, such that adjacent elements do not emit light simultaneously. The amount of light emitted by each light emitting element is calculated, based on the output of the light detecting sensor. In this method, peaks in the output of the light detecting sensor are detected, and the central positions of individual light emitting elements are specified based on the detected peaks, in order to establish correspondences among the detected amounts of light and individual light emitting elements.

There are cases in which the diameters of the lenses in the lens array are close to the arrangement pitch of the light emitting elements. In these cases, the method for measuring the amount of light emitted by each light emitting element and uniformizing them cannot effectively correct fluctuation in the amount of light in the lens arrangement pitch period (in the case that the lenses are arranged contacting each other, this period is the lens diameter). This point will be described in detail below.

The aforementioned lens array is generally constituted by a plurality of rows of gradient index lenses. Adjacent rows of lenses are arranged such that a second row of lenses are inserted within the spaces between the lenses of a first row. That is, the lenses are in a staggered formation when viewed as a whole. When light emitted from the linear light emitting element array passes through this type of lens array, the amount of light that pass through the lens array fluctuate along the longitudinal axis (the direction that each row of lenses extends in) of the lens array, with the lens arrangement pitch as the period of fluctuation.

In the case that the linear light emitting element array is aligned with the longitudinal axis of the lens array, that is, the optical axis of each light emitting element is arranged along the longitudinal axis, the fluctuations in amounts of light are cancelled by the lenses at either side of the row of lenses in the staggered pattern. Therefore, the fluctuation in the amount of exposure light is not severe. However, in cases in which the linear light emitting element array is positioned far from the longitudinal axis, the cancellation effect is decreased. Therefore, the fluctuation in the amount of exposure light becomes severe. In the case that the amount of exposure light fluctuates, the aforementioned striped irregularities are generated.

FIG. 2 is a graph that illustrates examples of fluctuation in the amount of light across the longitudinal direction of a lens array. The numerical values assigned to each of the curves represent the amount of offset of a linear light emitting element array with respect to the lens array. That is, the curve labeled±0 μm represents the fluctuation in the amount of light in the case that the linear light emitting element array is aligned with the longitudinal axis of the lens array.

The occurrence of fluctuation in the amount of exposure light is not limited to cases in which a lens array constituted by lenses in a staggered arrangement is employed. Even in the case that a lens array constituted by a single row of lenses is employed, if the linear light emitting element array is provided such that the optical axes of the light emitting elements are shifted from the longitudinal direction of the lens array, the amount of exposure light fluctuates along the longitudinal axis of the lens array, as the lens arrangement pitch as the period of fluctuation.

The aforementioned fluctuation in the amounts of light due to the lens array will be described in detail with reference to FIGS. 3, 4, and 5. FIG. 3 illustrates an example of a distribution of detected amounts of light when light emitting elements of a linear light emitting element array are uniformly caused to emit light, in the case that there is very little fluctuation due to a lens array. In the present example, the arrangement pitch of the light emitting elements is 0.1 mm. In this case, the waveform of the detected light amount signal regarding each light emitting element assumes peak values at the centers of the elements. FIG. 4 illustrates an example of fluctuation properties of a lens array. FIG. 5 illustrates the distribution of detected amounts of light when light emitting elements of a linear light emitting element array are uniformly caused to emit light, in the case that a lens array having the fluctuating properties illustrated in FIG. 4 is employed. Note that in the example of FIG. 4, the period of fluctuation in the amounts of light, which is the lens arrangement pitch of the lens array, is 0.3 mm.

As can be seen from FIG. 5, the waveform of the detected light amount signal is influenced by the fluctuating properties of the lens array, and the peaks are inclined. That is, the amounts of light that pass through the lens array are inclined. The shapes of these inclinations in the amounts of light cannot be changed, even if the amounts of light emitted from the light emitting elements are adjusted. Therefore, residual fluctuations would remain, if conventional correcting methods are employed, which would generate striped irregularities in exposed images.

Problems that occur in exposure heads that employ auto light emitting elements, such as organic EL elements, have been described. However, similar problems occur in other types of light emitting element arrays, such as those which are combinations of a light source and light modulating elements, such as liquid crystals or PLZT's. Note that in the present specification, the aforementioned combinations of the light source and the light modulating elements are also referred to as “light emitting elements”, because they are elements that emit exposure light.

### SUMMARY OF THE INVENTION

The present invention has been developed in view of the circumstances described above. It is an object of the present invention to provide a method for correcting the amount of light emitted by an exposure head constituted by a linear light emitting element array and a lens array, which is capable of deemphasizing irregularities in image density that occur due to fluctuations in the amount of light across the longitudinal axis of the arrays.

It is another object of the present invention to provide an exposure apparatus which is capable of implementing the method for correcting the amount of light emitted from an exposure head as described above.

The method for correcting the amount of light emitted by an exposure head according to the present invention is a method for correcting the amount of light emitted from an exposure head comprising: a linear light emitting element array, constituted by a plurality of light emitting elements which are aligned in a single row, in which the amount of light emitted from each light emitting element is independently controlled based on image signals that bear an image to be exposed; and a lens array, constituted by a plurality of ×1 magnification lenses which are aligned parallel to the row of light emitting elements, for focusing the light emitted from the light emitting elements onto a photosensitive material which is the target of exposure, wherein:

the amount of light emitted from each of the light emitting elements is corrected such that the period of fluctuation in the amount of light, which is a period of the lens arrangement pitch within the lens array, is shortened.

Note that the correction of the amount of light emitted from each light emitting element may comprise the steps of:

each of the light emitting elements of the linear light emitting element array are caused to emit light uniformly, based on a common light emission command;

the amount of light emitted by the lens array is measured at an optical measuring pitch less than or equal to the lens arrangement pitch across the entire length of the linear light emitting element array;

the amount of light is integrated within sections which are equal to the lens arrangement pitch at each boundary between two adjacent light emitting elements;

a correction coefficient is derived for each light emitting element, based on the integrated amount of light derived for at least the two boundaries at both sides of the light emitting element; and

the amounts of light, which are controlled based on the image signals, are corrected for each light emitting element based on the correction coefficient therefor, when exposing the photosensitive material.

The correction coefficient may be derived by a method wherein:

n/n+1 denotes the boundary between an n^{th} light emitting element and an (n+1) th light emitting element;

L(n/n+1) denotes the integrated amount of light at the boundary (n/n+1);

an average value L0 of the integrated amount of light for all of the boundaries is calculated;

a correction coefficient for the boundary n/n+1 is calculated as K(n/n+1)=1−L(n/n+1)/L0; and

the correction coefficient Pn for an n^{th} light emitting element is calculated based on the formula:
Pn=1−Q{−K(n−2/n−1)+K(n−1/n)+K(n/n+1)−K(n+1/n+2)}.

Note that the present invention decreases fluctuations in amounts of light due to inclinations in the amounts of light within the light emitting elements caused by the lens array. There are cases in which the amounts of light emitted by the light emitting elements themselves fluctuate greatly. In these cases, it is desirable to correct the amounts of light emitted from each of the light emitting elements to be uniform, prior to executing the above correction.

The exposure apparatus according to the present invention is an exposure apparatus that implements the aforementioned method for correcting the amount of light emitted from an exposure head, comprising:

an exposure head, comprising a linear light emitting element array, constituted by a plurality of light emitting elements which are aligned in a single row, in which the amount of light emitted from each light emitting element is independently controlled based on image signals that bear an image to be exposed; and a lens array, constituted by a plurality of ×1 magnification lenses which are aligned parallel to the row of light emitting elements, for focusing the light emitted from the light emitting elements onto a photosensitive material which is the target of exposure;

sub scanning means, for moving the exposure head and the photosensitive material relative to each other in a direction perpendicular to the arrangement direction of the light emitting elements;

memory means, for recording correction coefficients for correcting the amount of light emitted from each of the light emitting elements such that the period of fluctuation in the amount of light, which is a period of the lens arrangement pitch within the lens array, is shortened therein; and

correction means, for correcting the amounts of light emitted from the light emitting elements, which are controlled based on the image signals, based on the correction coefficients, which are read out from the memory means.

FIG. 16 illustrates visibility characteristics with respect to periodic density fluctuations, such as the aforementioned striped irregularities. These characteristics are for a case in which the observation distance is 15 cm. The horizontal axis represents the spatial frequency of the density fluctuations, and the vertical axis represents visible limits of optical density differences. As illustrated here, the visible characteristics of periodic density fluctuations are maximal when the density fluctuation frequency is approximately 0.7 c (cycles)/mm. That is, the smallest density differences can be visually discerned at this frequency. As the frequency increases from this value, the visibility characteristics decrease.

Here, the spatial frequency of the aforementioned striped irregularities, which occur with the lens arrangement pitch of the lens array as its period is generally greater than 1 c/mm, due to factors such as that the diameters of the lenses are less than 1 mm. In FIG. 16, in the region at which the spatial frequency is greater than 1 c/mm, the visibility characteristics of the periodic density fluctuations decreases gradually as the spatial frequency increases, that is, as the period of density fluctuation decreases.

In view of this fact, the method for correcting the amount of light emitted from an exposure head according to the present invention corrects the amounts of light emitted from each light emitting element such that such that the period of fluctuation in the amount of light, which is a period of the lens arrangement pitch within the lens array, is shortened. Therefore, reduction of the visibility of striped irregularities within exposed images is made possible.

### BRIEF DESCRIPTION OF THE DRAWINGS

FIG. 1 is a graph that illustrates an example of the distribution of amounts of light in the longitudinal direction of a linear light emitting element array.

FIG. 2 is a graph that illustrates examples of fluctuation in the amount of light across the longitudinal direction of a lens array.

FIG. 3 is a graph that illustrates an example of a distribution of detected amounts of light when light emitting elements of a linear light emitting element array are uniformly caused to emit light.

FIG. 4 is a graph that illustrates an example of fluctuation properties of a lens array.

FIG. 5 is a graph illustrates an example of the distribution of detected amounts of light when light emitting elements of a linear light emitting element array are uniformly caused to emit light.

FIG. 6 is a partially sectional front view of an organic EL exposure apparatus according to a first embodiment of the present invention.

FIG. 7 is a partially sectional side view of the organic EL exposure apparatus of FIG. 6.

FIG. 8 is a plan view of a lens array, which is employed in the organic EL exposure apparatus of FIG. 6.

FIG. 9 is a front view of the means for performing measurement of light emitted from an exposure head of the exposure apparatus of FIG. 6.

FIG. 10 is a plan view of the means for performing measurement of light emitted from the exposure head of the exposure apparatus of FIG. 6.

FIG. 11 is a plan view of another example of a means for performing measurement of light emitted from the exposure head of the exposure apparatus of FIG. 6.

FIG. 12 is a graph that illustrates an example of the distribution of moving averages of light amount measurement signals.

FIG. 13 is a graph that illustrates another example of the distribution of moving averages of light amount measurement signals.

FIG. 14 illustrates an example of distribution properties of amounts of emitted light for a linear light emitting element array, when correction has been performed to uniformize the amounts of emitted light.

FIG. 15 is a graph that illustrates an example of the distribution of moving averages-of light amount measurement signals, when correction has been performed to uniformize the amounts of emitted light.

FIG. 16 illustrates visibility characteristics with respect to periodic density fluctuations, for humans.

FIG. 17 is a diagram for explaining the method by which correction coefficients are derived in the present invention.

FIG. 18 is a diagram for explaining the method by which correction coefficients are derived in the present invention.

FIG. 19 is a diagram for explaining the method by which correction coefficients are derived in the present invention.

FIG. 20 is a graph that illustrates an example of the distribution of moving averages of light amount measurement signals, when correction of amounts of emitted light according to the present invention has been performed.

FIG. 21 is a graph that illustrates the results of high speed Fourier transform on light amount measurement signals when correction of amounts of emitted light according to the present invention has been performed.

FIG. 22 is a graph that illustrates the results of high speed Fourier transform on image signals read out from an image, which has been exposed after correction of amounts of emitted light according to the present invention has been performed.

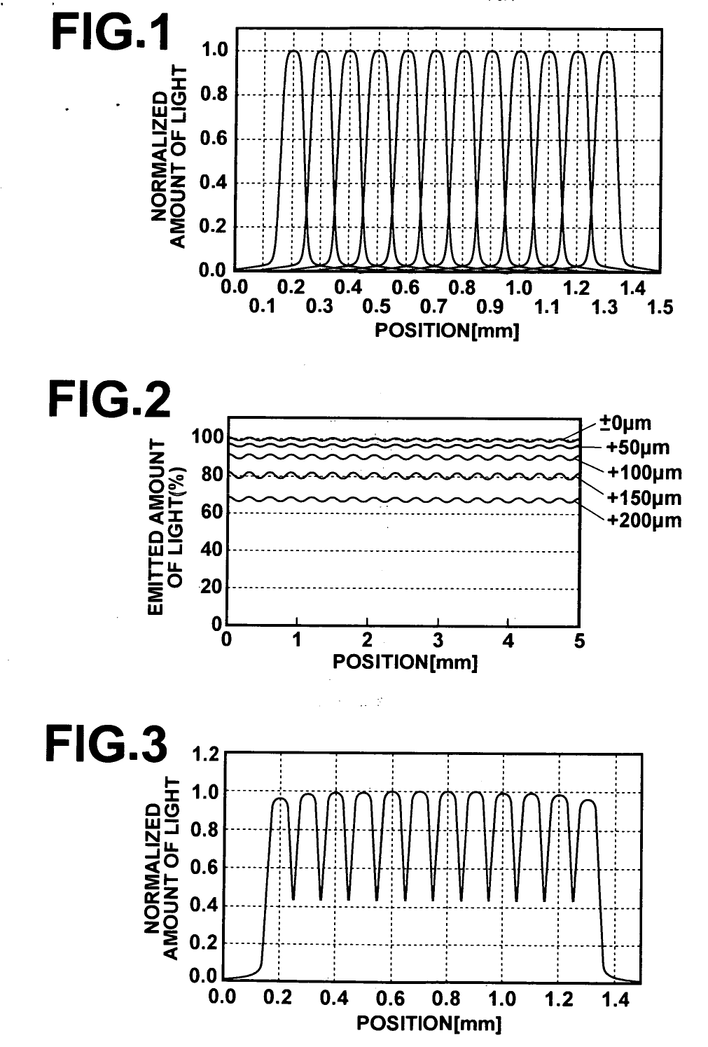

### DESCRIPTION OF THE PREFERRED EMBODIMENTS

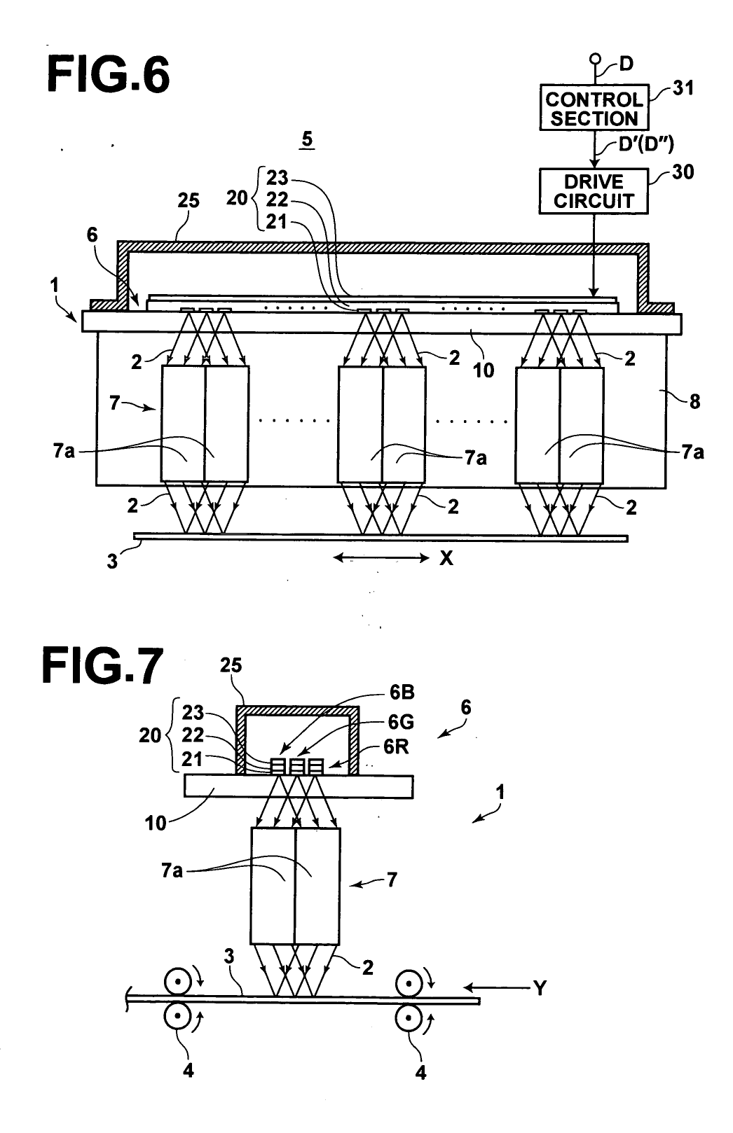

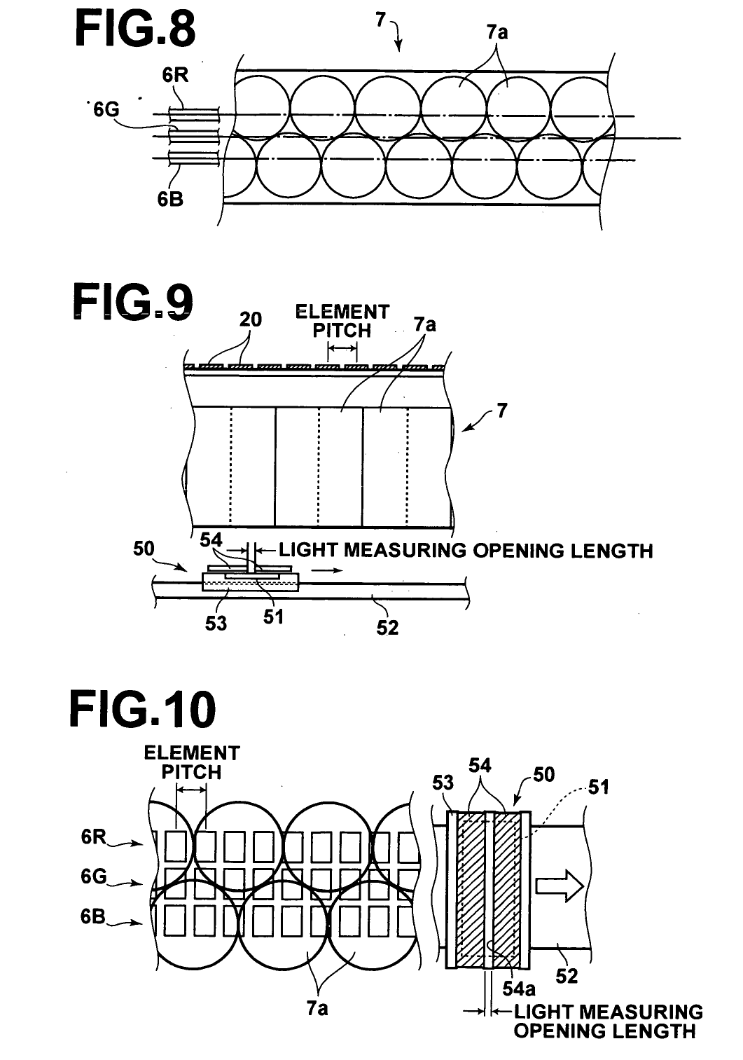

Hereinafter, embodiments of the present invention will be described with reference to the attached drawings. FIG. 6 is a partially sectional front view of an organic EL exposure apparatus 5 according to a first embodiment of the present invention. FIG. 7 is a partially sectional side view of the organic EL exposure apparatus 5. FIG. 8 is a plan view of a lens array 7, which is employed in the organic EL exposure apparatus 5.

First, a description will be given regarding the basic construction of the organic EL exposure apparatus 5, with reference to FIGS. 6 through 8. As illustrated in the figures, the exposure apparatus 5 comprises: an exposure head 1; and a sub scanning means 4, for conveying a color photosensitive material 3, which is provided at a position that receives irradiation of exposure light 2 emitted from the exposure head 1, in the direction indicated by arrow Y of FIG. 7 at a constant speed.

The exposure head 1 comprises: an organic EL panel 6; a gradient index lens array 7 for focusing an image borne by the exposure light 2 emitted from the organic EL panel 6 onto the color photosensitive material 3 at ×1 magnification, provided at a position at which it receives the exposure light 2; and a holding means 8 (not shown in FIG. 7), for holding the lens array 7 and the organic EL panel 6.

The gradient index lens array 7, which is a ×1 magnification lens array, comprises two rows of lenses, as illustrated in FIG. 8. Each row of lenses comprises a great number of miniature gradient index lenses 7a for focusing the exposure light 2, which are arranged in a main scanning direction (direction indicated by arrow X in FIG. 6) perpendicular to the sub scanning direction Y. The lenses 7a are arranged in a staggered pattern in the gradient index lens array 7. That is, the plurality of gradient index lenses 7a of one row of lenses are positioned between the plurality of gradient index lenses 7a of the other row of lenses.

The exposure apparatus 5 of the present embodiment exposes color images onto the color photosensitive material 3, for example, a full color silver salt film. The organic EL panel 6 of the exposure head 1 comprises: a red linear light emitting element array 6R; a green linear light emitting element array 6G; and a blue linear light emitting element array 6B. The linear light emitting element arrays 6R, 6G, and 6B are arranged to be adjacent to each other in the sub scanning direction Y. The linear light emitting element arrays 6R, 6G, and 6B are each constituted by red organic EL light emitting elements, green organic EL light emitting elements, and blue organic EL light emitting elements, respectively.

Note that in FIG. 6 and FIG. 7, one of the light emitting elements is denoted as an organic EL light emitting element 20, as a representative example. Each organic EL light emitting element 20 is formed by a transparent anode 21, an organic compound layer 22 that includes a light emitting layer, and a metallic cathode 23, which are layered in this order on a transparent substrate 10 (such as glass) by vapor deposition. The red organic EL light emitting elements, the green organic EL light emitting elements, and the blue organic EL light emitting elements are formed by employing light emitting layers that emit red light, green light, and blue light, respectively.

The linear light emitting element arrays 6R, 6G, and 6B are driven by a drive circuit 30, which is illustrated in FIG. 6. The drive circuit 30 comprises: a cathode driver that sequentially sets the metallic cathode 23, which functions as a scanning electrode, to an ON state at a predetermined period; and an anode driver that sets the transparent anode 21, which functions as a signal electrode, to an ON state, based on an image data set D that represents a full color image. The linear light emitting element arrays 6R, 6G, and 6B are driven by a passive matrix sequential line selectipon driving method. The operation of the drive circuit 30 is controlled by a control section 31 that corrects the image data set D and outputs an image data set D′. Note that the correction of the image data set D will be described in detail later.

The elements that constitute each of the organic EL light emitting elements 20 are provided within a sealing member 25, constituted by a stainless steel can, for example. That is, the edge of the sealing member 25 is adhesively attached to the transparent substrate 10, to seal the organic EL light emitting element within the sealing member 25, which is filled with dry nitrogen gas.

When voltage is applied between the metallic cathode 23 and the transparent anode 21, which extends so as to cross the metallic cathode 23, current flows in the organic compound layer 22 at the positions at which the electrodes intersect. The current causes the light emitting layer within the organic compound layer to emit light. The emitted light passes through the transparent anode 21 and the transparent substrate 10, and is emitted toward the exterior of the element 20 as the exposure light 2.

The transparent anode 21 transmits at least 50%, and preferably at least 70% of visible light within a wavelength range of 400 nm to 700 nm. Known compounds, such as tin oxide, indium tin oxide (ITO), and indium zinc oxide may be employed as the material of the transparent anode 21. Alternatively, thin films formed by metals having high work functions, such as gold and platinum, may be employed. Further, organic compounds, such as polyaniline, polythiophene, polypyrrole, and dielectrics thereof, maybe employed. Note that “Developments in Transparent Conductive Films” Y. Sawada, Ed., CMC Publishing, 1999 contains detailed disclosure regarding transparent conductive films. The transparent conductive films described in the above document may be applied to the present invention. The transparent anode 21 maybe formed on the transparent substrate 10 by a vacuum vapor deposition method, a sputtering method, an ion plating method, and the like.

Meanwhile, the organic compound layer 22 may be of a single layer construction constituted by only the light emitting layer, or it may be of a multiple layer construction. In the latter case, the organic compound layer 22 may comprise: a hole injection layer; a hole transport layer; an electron injection layer; an electron transport layer; and other layers as appropriate. As specific examples of the layer structure of the organic compound layer 22 and the electrodes, there are: an anode/hole injection layer/hole transport layer/light emitting layer/electron transport layer/cathode construction; an anode/light emitting layer/electron transport layer/cathode construction; and an anode/hole transport layer/light emitting layer/electron transport layer/cathode construction. Pluralities of the light emitting layer, the hole transport layer, the hole injection layer, and the electron injection layer may be provided.

It is preferable for the metallic cathode 23 to be formed of: an alkali metal having a low work function, such as Li and K; an alkali earth metal such as Mg and Ca; or alloys or amalgams of these metals with Ag or Al. An electrode formed by the above materials may be further coated with highly conductive metals that have high work functions, such as Ag, Al, and Au, in order to balance preservation stability and electron injection properties of the cathode. Note that the metallic cathode 23 may also be formed by a vacuum vapor deposition method, a sputtering method, anion plating method, and the like.

Hereinafter, the operation of the exposure apparatus 5 having the above construction will be described. Note that here, the number of pixels in the main scanning direction of the linear light emitting element arrays 6R, 6G, and 6B, that is, the number of transparent anodes in each of the arrays, is designated as n. During image exposure onto the color photosensitive material 3, the color photosensitive material 3 is conveyed in the direction of arrow Y by the sub scanning means 4. The cathode driver of the drive circuit 30 sequentially selects one of the three metallic cathodes 23 to be in an ON state, synchronized with the conveyance of the color photosensitive material 3.

The first metallic cathode 23, that is, the metallic cathode 23 that constitutes the red linear light emitting element array 6R, is selected to be ON in this manner. During the ON state of the first metallic cathode 23, the anode drive of the drive circuit 30 connects each of the 1^{st}, 2^{nd}, 3^{rd}, . . . n^{th} transparent anodes 21 to a constant current source. The connections are established for time periods corresponding to the red density of the 1^{st}, 2^{nd}, 3^{rd}, . . . n^{th} pixel of a first main scanning line, as represented by the image data set D (the time periods are corrected, which will be described later). Thereby, pulse width current that corresponds to image data flows through the organic compound layer 22 (refer to FIG. 6) between the transparent anode 21 and the metallic cathode 23, and red light is emitted from the organic compound layer 22.

The red exposure light 2 emitted from the red linear light emitting element array 6R is focused on the color photosensitive material 3 by the lens array 7. Thereby, the 1^{st}, 2^{nd}, 3^{rd}, . . . n^{th} pixel of the first main scanning line are exposed and colored red on the color photosensitive material 3.

Next, the second metallic cathode 23, that is, the metallic cathode 23 that constitutes the green linear light emitting element array 6G, is selected to be ON. During the ON state of the second metallic cathode 23, the anode drive of the drive circuit 30 connects each of the 1^{st}, 2^{nd}, 3^{rd}, . . . n^{th} transparent anodes 21 to a constant current source. The connections are established for time periods corresponding to the green density of the 1^{st}, 2^{nd}, 3^{rd}, . . . n^{th} pixel of a first main scanning line, as represented by the image data set D. Thereby, pulse width current that corresponds to image data flows through the organic compound layer 22 between the transparent anode 21 and the metallic cathode 23, and green light is emitted from the organic compound layer 22.

The green exposure light 2 emitted from the green linear light emitting element array 6R is focused on the color photosensitive material 3 by the lens array 7. Thereby, the 1^{st}, 2^{nd}, 3^{rd}, . . . n^{th} pixel of the first main scanning line are exposed and colored green on the color photosensitive material 3. Note that the color photosensitive material 3 is being conveyed at the constant speed. Therefore, the green light is irradiated on the portion of the color photosensitive material 3, which has already been exposed by red light.

Next, the third metallic cathode 23, that is, the metallic cathode 23 that constitutes the blue linear light emitting element array 6R, is selected to be ON. During the ON state of the third metallic cathode 23, the anode drive of the drive circuit 30 connects each of the 1^{st}, 2^{nd}, 3^{rd}, . . . n^{th} transparent anodes 21 to a constant current source. The connections are established for time periods corresponding to the blue density of the 1^{st}, 2^{nd}, 3^{rd}, . . . n^{th} pixel of a first main scanning line, as represented by the image data set D. Thereby, pulse width current that corresponds to image data flows through the organic compound layer 22 between the transparent anode 21 and the metallic cathode 23, and blue light is emitted from the organic compound layer 22.

The blue exposure light 2 emitted from the blue linear light emitting element array 6R is focused on the color photosensitive material 3 by the lens array 7. Thereby, the 1^{st}, 2^{nd}, 3^{rd}, . . . n^{th} pixel of the first main scanning line are exposed and colored blue on the color photosensitive material 3. Note that the color photosensitive material 3 is being conveyed at the constant speed. Therefore, the green light is irradiated on the portion of the color photosensitive material 3, which has already been exposed by red light and green light. The first full color main scanning line is exposed and recorded on the color photosensitive material 3 by the steps described above.

Thereafter, the sequential line selection of the metallic cathodes returns to the first metallic cathode 23. During the ON state of the first metallic cathode 23, the anode drive of the drive circuit 30 connects each of the 1^{st}, 2^{nd}, 3^{rd}, . . . n^{th} transparent anodes 21 to a constant current source. The connections are established for time periods corresponding to the red density of the 1^{st}, 2^{nd}, 3^{rd}, . . . n^{th} pixel of a second main scanning line, as represented by the image data set D. Thereby, pulse width current that corresponds to image data flows through the organic compound layer 22 between the transparent anode 21 and the metallic cathode 23, and red light is emitted from the organic compound layer 22.

The red exposure light 2 emitted from the red linear light emitting element array 6R is focused on the color photosensitive material 3 by the lens array 7. Thereby, the ^{st}, 2^{nd}, 3^{rd}, . . . n^{th} pixel of the second main scanning line are exposed and colored red on the color photosensitive material 3.

The operations described above are repeated to expose the second full color main scanning line. Further, the color main scanning lines are sequentially exposed in the sub scanning direction Y, and a two dimensional color image constituted by a great number of main scanning lines is exposed on the color photosensitive material 3. Note that in the present embodiment, each colored exposure light is pulse width modulated, and the amounts of light emitted are controlled according to image data, to expose a color gradation image.

Hereinafter, a method will be described, by which striped irregularities that occur due to fluctuations in light emitting properties of the organic EL light emitting elements 20 and fluctuations in amounts of light caused by the lens array 7 are reduced, and further, the visibility of the striped irregularities are reduced. Prior to performing image exposure as described above, a light measuring process is administered in order to correct the amount of light, in the exposure apparatus 5. FIGS. 9 and 10 are front and plan views of the means that perform the light measuring process, respectively. As illustrated in FIGS. 9 and 10, the light measuring means 50 comprises: a photoreceptor 51, which is provided at the same position that the color photosensitive material is provided at during image exposure; a moving means 53 for holding the photoreceptor 51, mounted on a guide 52; and a light shielding member 54 for covering the light receiving surface of the photoreceptor 51 such that only a portion thereof is exposed.

The moving means 53 is formed such that it is capable of moving intermittently along the guide 52 in the arrangement direction of the lenses 7a of the lens array 7. In the present example, the diameter of each lens 7a is 300 μm. The dimensions of each of the organic EL light emitting elements 20 of the linear light emitting arrays 6R, 6G, and 6B are 80×80 μm. The pitch of intermittent movement of the moving means 53 is 1/20 of the element arrangement pitch, at 5 μm. An elongate slit 54a that extends in the direction perpendicular to the movement direction of the moving means 53 is formed in the light shielding member 54. Thereby, only the portion of the light receiving surface corresponding to the slit 54a is exposed. The width of the slit 54a, that is, the light measuring opening length, is set to be 5 μm, which is the same as the light measuring pitch.

In the light measuring process, first, the moving means 53 is placed at an end of the guide 52. Then, a constant current is supplied to all of the organic EL light emitting elements 20 of the red linear light emitting element array &r, for example, based on a common light emission command signal, to cause them to emit light uniformly. Thereafter, the moving means 53 is moved intermittently, and the amount of light emitted through the lens array 7 is measured at every stop in the intermittent movement. The light measurement signals output from the photoreceptor 51 is output to the control section 31, illustrated in FIG. 6.

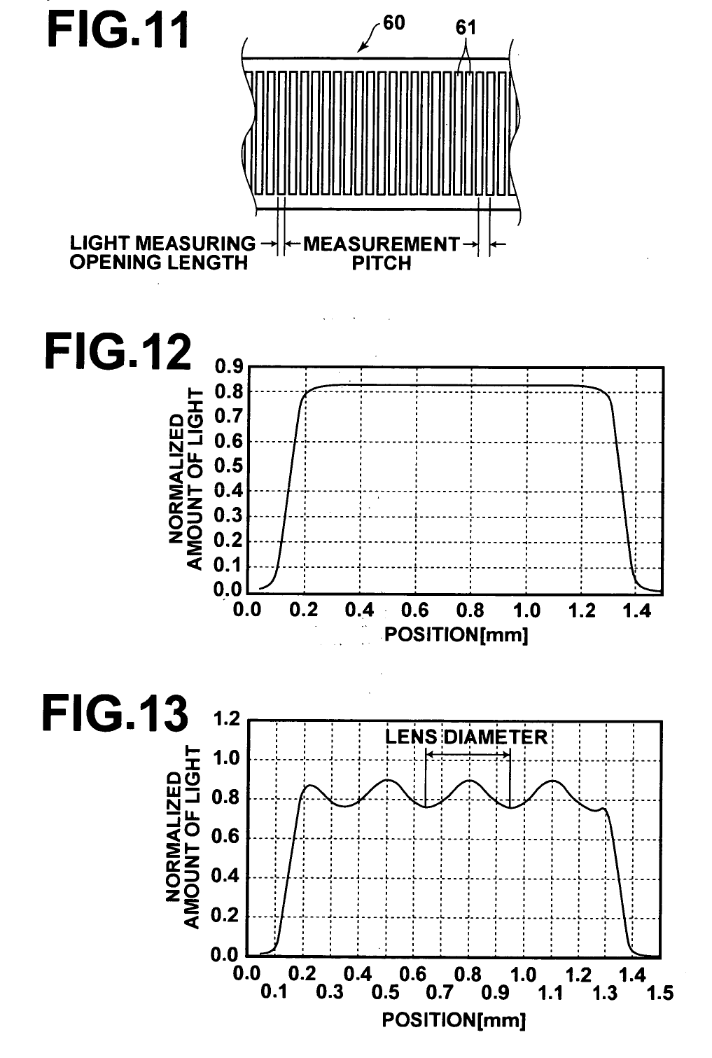

Note that a photoreceptor element array 60, in which elongate photoreceptor elements 61 are arranged in the arrangement direction of the organic EL light emitting elements 20 as illustrated in FIG. 11, may be employed instead of moving the photoreceptor 51 intermittently. In this case, the width of the photoreceptor elements 61 becomes the light measuring opening length, and the arrangement pitch of the photoreceptor elements 61 becomes the measurement pitch.

The control section 31 illustrated in FIG. 6 temporarily stores the light measurement signals output from the photoreceptor 51 in an internal memory (not shown). In order to perform correction of the amounts of emitted light to reduce fluctuations therein, the signals within a section equal to the element pitch are integrated for each organic EL light emitting element 20. Specifically, in the present embodiment, the measured amounts of light of ten light measurement points at both sides of the center of an organic EL light emitting element 20 in the main scanning direction are totaled. The totaled amounts of light is multiplied by 1/20, to obtain an average value (moving average), which is designated as the integrated value for the organic EL light emitting element 20.

Note that in this case, it is not necessary to accurately determine the center position of the organic EL light emitting element 20. The only requirement is that the twenty measurement points are distributed to the right and left of the center of the organic EL light emitting element 20, ten per side. For example, the center of the light emitting element is determined to be between a measurement point A, at where an extremely great amount of light has been measured, and a measurement point B, which is one of two measurement points adjacent to the measurement point A at where a greater amount of light has been measured. The measured amounts of light of ten measurement points from measurement point A opposite the side of the center of the light emitting element (including measurement point A), and ten measurement points from measurement point B opposite the side of the center of the light emitting element (including measurement point B) may be provided for the calculations for the moving average value.

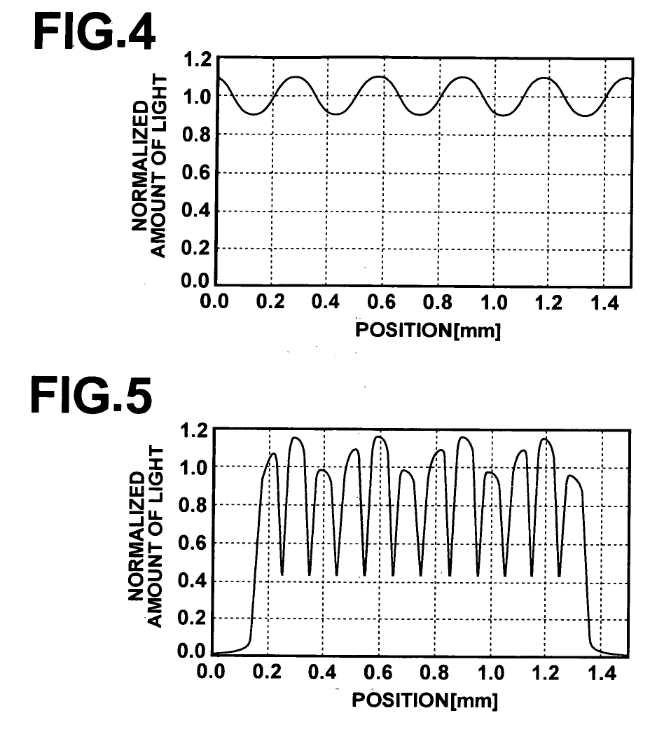

In the case that there are no fluctuations in the light emitting properties of the organic EL light emitting elements 20 of the red linear light emitting element array 6R, and there are no fluctuations in amounts of light due to the lens array 7, the distribution of the measured amounts of light output by the photoreceptor 51 will be that illustrated in FIG. 3. If the moving average values obtained in this case are graphed and smoothed, the resulting graph would be that illustrated in FIG. 12. In contrast, in the case that there are no fluctuations in the light emitting properties of the organic EL light emitting elements 20, yet the lens array 7 has the fluctuation properties illustrated in FIG. 4, the distribution of the measured amounts of light output by the photoreceptor 51 will be that illustrated in FIG. 5. If the moving average values obtained in this case are graphed and smoothed, the resulting graph would be that illustrated in FIG. 13. As illustrated in FIG. 13, the light emitted through the lens array 7 exhibits fluctuations having the diameter of the lenses in the lens array 7 (in this case, the lens arrangement pitch) as its period.

The properties illustrated in FIG. 13 combine the light emitting properties of the red linear light emitting element array 6R across the main scanning direction and the fluctuation properties due to the lens array 7. The control section 31 derives correction coefficients S for each organic EL light emitting element, based on these properties. Here, the correction coefficient S for an nth organic EL light emitting element 20 of the red linear light emitting element array 6R will be designated as Sn. The correction coefficient Sn is a value calculated by dividing a constant by the value of the n^{th} organic EL light emitting element related to the above properties, for example. The correction coefficients Sn are recorded in the memory within the control section 31.

As mentioned previously, when image exposure is performed based on the image data set D, the control section 31 converts the image data set D that causes organic EL light emitting elements 20 of the red linear light emitting element array into the image data set D′, by multiplying the image data set D by the correction coefficients Sn corresponding to the organic EL light emitting elements 20. That is, in this case, the corrected image data set D7 is input to the drive circuit 30, and the amounts of light emitted by the organic EL light emitting elements 20 are controlled based on the corrected image data set D′.

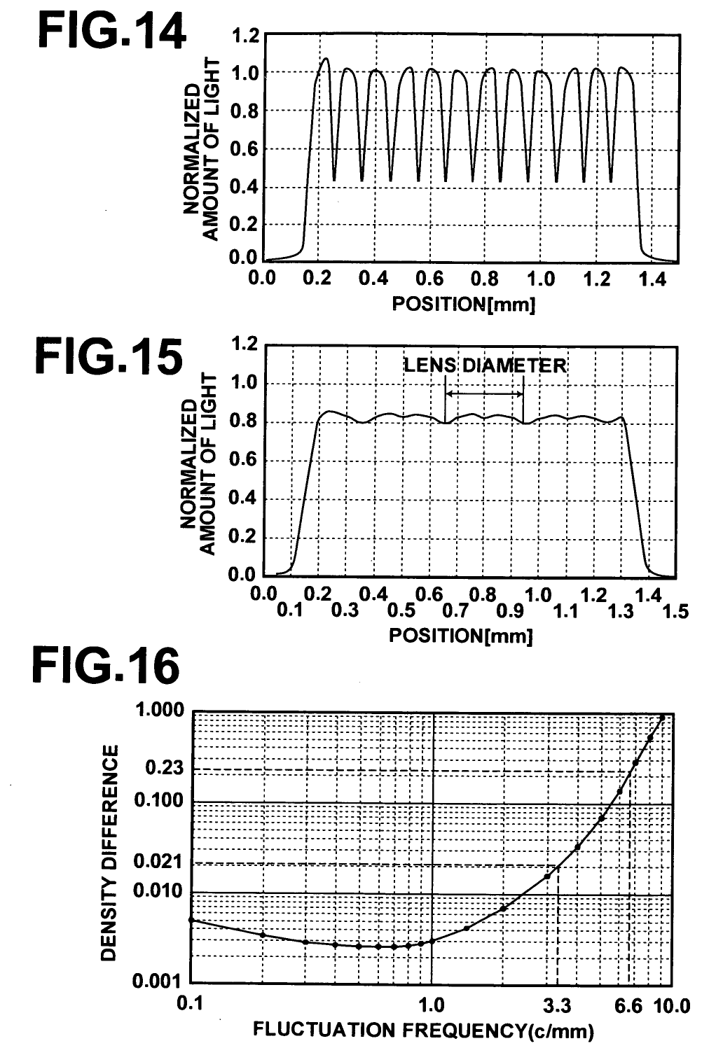

FIG. 14 illustrates an example of distribution properties of amounts of emitted light for twelve elements, when all of the organic EL light emitting elements 20 of the red linear light emitting element array 6R are caused to emit light based on the corrected image data set D′, in a case that the image data set D prior to correction causes the light emitting elements 20 to uniformly emit light. In this case, the distribution of the moving averages become that illustrated in FIG. 15, which approximates the distribution illustrated in FIG. 12.

Correction of the amounts of light emitted from the red linear light emitting element array 6R has been described above. The same processes for determining the correction coefficients Sn are administered for the green linear light emitting element array 6G and the blue linear light emitting element array 6B. During image exposure, the same corrections are performed for the amounts of light emitted from the green and blue linear light emitting element arrays 6G and 6B. Thereby, the amounts of light emitted by the organic EL light emitting elements 20 of the linear light emitting element arrays 6G and 6B are corrected to resolve the fluctuation properties illustrated in FIG. 13. Accordingly, the striped irregularities that occur in the exposed image due to the fluctuation properties are reduced.

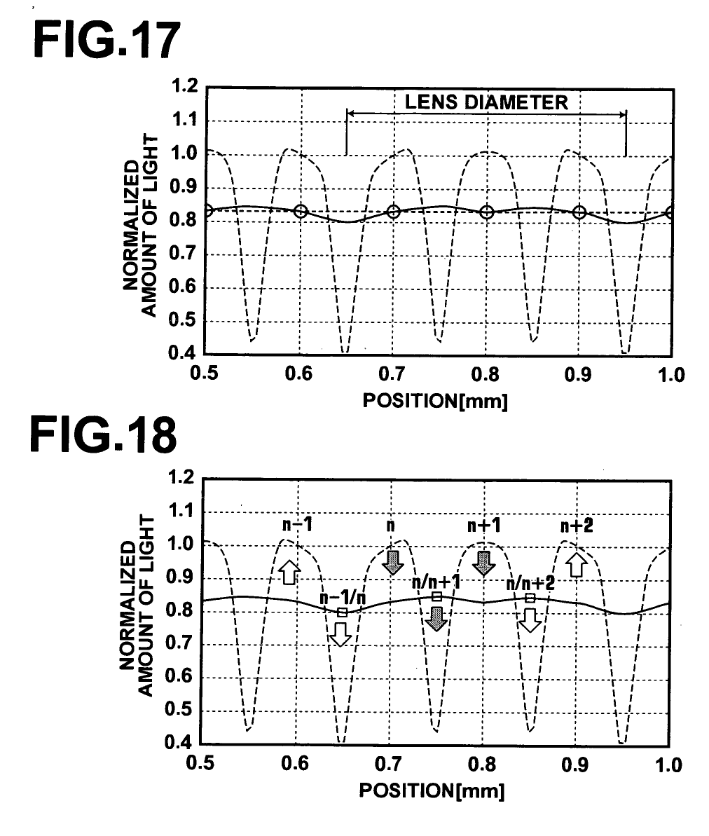

As illustrated in FIG. 15, fluctuations in the amounts of light emitted through the lens array 7 are reduced compared to a case in which the above correction is not performed. However, slight fluctuations still remain, with the diameter of the lenses of the lens array 7 as its period. FIG. 17 is a magnified view of the distribution of the moving averages, in which the light emitting properties of the organic EL light emitting elements 20 are also illustrated, indicated by broken lines. The integrated values at the center positions of the organic EL light emitting elements 20 are uniform. However, as can be seen by the inclinations of the emitted amounts of light of each of the light emitting elements 20, slight fluctuations remain in the amounts of light, with the lens diameter as its period. In the present embodiment, further correction is performed, in order to reduce the visibility of the striped irregularities due to these slight fluctuations. The correction will be described in detail hereinafter.

First, correction regarding the red linear light emitting element array 6R will be described. All of the organic EL light emitting elements 20 of the red linear light emitting element array 6R are uniformly caused to emit light, based on a common light emission command signal that supplies current thereto. At this time, the common light emission command signal is multiplied by the correction coefficients Sn. This corresponds to the process for converting the image data set D to the corrected image data set D′. Next, the amounts of light emitted through the lens array 7 are measured by the light measuring means 50 illustrated in FIGS. 9 and 10. At this time as well, the intermittent movement pitch of the moving means 53, that is, the measurement pitch, is set to 5 μm. The measurement signals output from the photoreceptor 51 are input to the control section 31 illustrated in FIG. 6.

The control section 31 illustrated in FIG. 6 temporarily stores the light measurement signals output from the photoreceptor 51 in the internal memory (not shown). The signals within a section equal to the element pitch are integrated for each boundary position between adjacent organic EL light emitting elements 20. Specifically, in the present embodiment, the measured amounts of light of ten light measurement points at both sides of the boundary position between a pair of adjacent organic EL light emitting elements 20 in the main scanning direction are totaled. The totaled amounts of light is multiplied by 1/20, to obtain an average value (moving average), which is designated as the integrated value for the boundary position.

Note that in this case as well, it is not necessary to accurately determine the boundary position between the adjacent organic EL light emitting elements 20. The only requirement is that the twenty measurement points are distributed to the right and left of the boundary position, ten per side.

The control section 31 derives correction coefficients for each organic EL light emitting element 20, based on the properties of the integrated values. First, the control section 31 derives correction coefficients K for the boundary positions. Here, n/n+1 denotes the boundary position between an n^{th} light emitting element and an (n+1)^{th} light emitting element of the red linear light emitting element array 6R. The moving average of the amounts of light at the boundary position (n/n+1) is designated as L(n/n+1). The average of the moving averages of all of the boundary positions is calculated and designated as L0. A correction coefficient K for the boundary position n/n+1 is calculated as K(n/n+1)=1−L(n/n+1)/L0. A correction coefficient Pn for an n^{th} light emitting element is calculated based on the formula:
Pn=1−Q{−K(n−2/n−1)+K(n−1/n)+K(n/n+1)−K(n+1/n+2)}.
Note that here, Q denotes a coefficient. The correction coefficients Pn are recorded in the memory within the control section 31.

During image exposure based on the image data set D, the control section 31 multiplies the image data set D by the correction coefficients Pn regarding the n^{th} organic EL light emitting elements 20 of the red linear light emitting element array 6R, to obtain a corrected image data set D″. The corrected image data set D″ is input to the drive circuit 30, and the amounts of light emitted by the organic EL light emitting elements 20 are controlled based on the corrected image data set D″.

Correction of the amounts of light emitted by the red linear light emitting element array 6R has been described above. The same processes for determining the correction coefficients Pn are administered for the green linear light emitting element array 6G and the blue linear light emitting element array 6B. During image exposure, the same corrections are performed for the amounts of light emitted from the green and blue linear light emitting element arrays 6G and 6B. Thereby, the amounts of light emitted by the organic EL light emitting elements 20 of the linear light emitting element arrays 6G and 6B are corrected such that the period of striped irregularities is shortened, compared to that prior to correction. Accordingly, the striped irregularities that occur in the exposed image become less visible. The reason that visibility is reduced has been described previously with reference to FIG. 16.

The light emission command signal that causes the organic EL light emitting elements to emit light uniformly during determination of the correction coefficients Pn is multiplied by the aforementioned correction coefficients Sn. Therefore, the amounts of light emitted by the linear light emitting element arrays 6R, 6G, and 6B during image exposure are also corrected to reduce the occurrence of the striped irregularities.

Note that it is not strictly necessary for the correction that reduces the occurrence of the striped irregularities to be performed. However, that it is preferable that the correction is performed goes without saying. In the case that this type of correction is performed, the correction is not limited to that employed in the present embodiment. That is, methods other than those that employ the correction coefficients Sn may be applied.

Next, the correction coefficients Pn will be described in further detail. In order to resolve the fluctuations in amounts of emitted light as illustrated in FIG. 17, it is necessary to decrease the amounts of light at boundary positions n/n+1 where the amount of light is high, as illustrated in FIG. 18. To this end, the amounts of light emitted by the nth and the (n+1)th organic EL light emitting elements 20 may be decreased. However, if the amounts of light emitted by these two organic EL light emitting elements 20 are decreased, the amounts of light emitted at boundary positions n−1/n and n+1/n+2 are also decreased. Accordingly, it becomes necessary to increase the amounts of light emitted by the (n−1)t^{h} and (n+2) th organic EL light emitting elements 20.

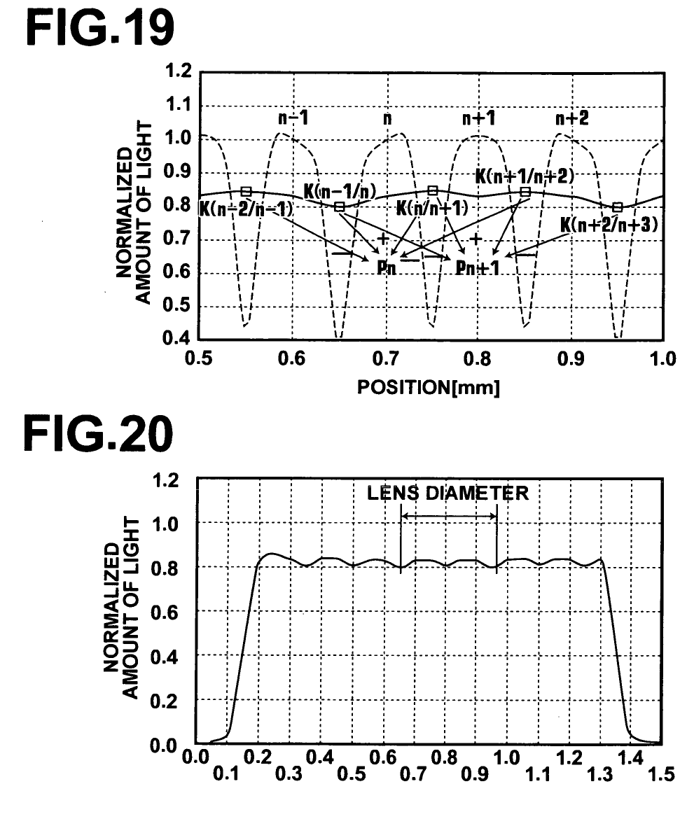

In the case that the correction coefficient K for the boundary position n/n+1 is designated as K(n/n+1)=1−L(n/n+1)/L0, the correction coefficients K(n−2/n−1) and K(n+1/n+2) are assigned minus signs, while the correction coefficients K(n−1/n) and K(n/n+1) are assigned plus signs, as illustrated in FIG. 19. The correction coefficients K are added, multiplied by a weighing coefficient Q, then subtracted from 1. That is, the above conditions can be satisfied, if correction coefficient Pn for an n^{th} organic EL light emitting element 20 is defined as 1−Q{−K(n−2)/(n−1}+K(n−1)/(n)+K(n)/(n+1)−K(n+1)/(n+2)}.

Note that the measured amount of light for a single boundary position reflects the controlled amounts of light of the two organic EL light emitting elements that define the boundary position. Therefore, the standard value for above weighing coefficient Q is 0.5. However, appropriate weighing coefficient values are dependent on the spread of the light beam emitted by an organic EL light emitting element 20. Therefore, correction effects can be optimized by adjusting the value of Q according to the characteristics of the light emitting element array and the lens array. As a result of experimentation, it has been found that desirable values of Q are within a range from 0.3 to 0.7.

By performing the correction described above, the distribution of the moving averages becomes that illustrated in FIG. 20. When the distribution of FIG. 20 is compared against that illustrated in FIG. 15, it can be seen that the period of fluctuations is converted to half the lens diameter (300 μm), that is, 150 μm. When this conversion in the period of fluctuation is applied to the density fluctuation frequency illustrated in FIG. 16, the density fluctuation frequency is converted to 3.3 c/mm to 6.6 c/mm. As is clear from FIG. 16, the visible limit of density differences changes from 0.021 to 0.23, at an observation distance of 15 cm. That is, striped irregularities cannot be visually observed unless the density thereof is approximately ten times in optical density, due to the correction being administered. In other words, the visibility of the fluctuations in amounts of light is reduced to approximately 1/10.

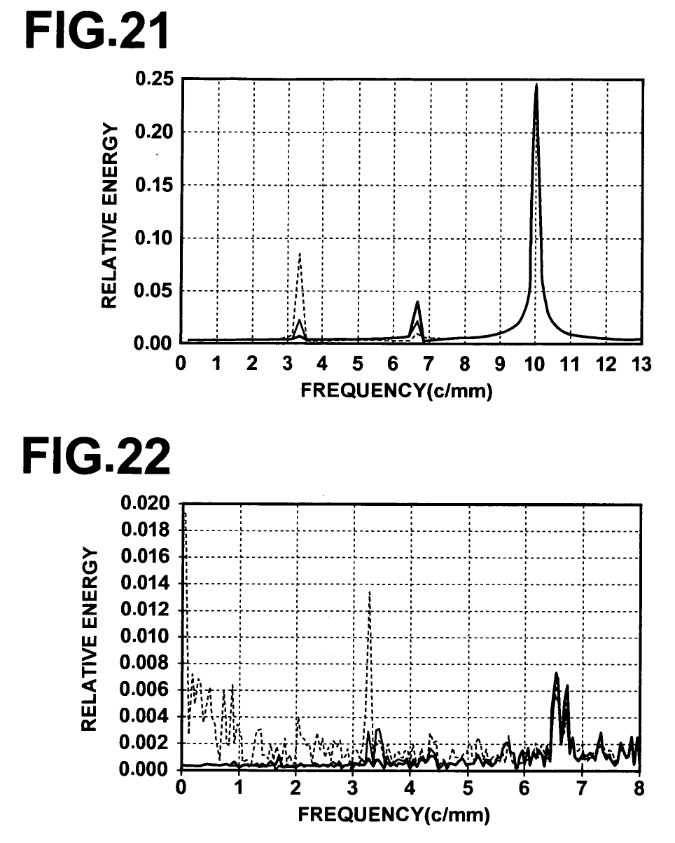

Next, the change in density fluctuation frequency will be described in detail. FIG. 21 is a graph that illustrates the results of light detection, when all of the organic EL light emitting elements 20 of the linear light emitting element array 6R of the exposure apparatus 5 are uniformly caused to emit light with and without correction. A light detector detects the light which is transmitted through the lens array 7, and high speed Fourier transform is administered on the detection signals. In FIG. 21, the broken line, the thin solid line, and the bold solid lines indicate the results for no correction, correction employing the correction coefficients Sn, and correction employing the correction coefficients Pn, respectively.

In FIG. 21, the spatial frequency component at 10 c/mm, where energy is highly concentrated, represents repetitive fluctuation components caused by the organic EL light emitting elements, which are arranged at a pitch of 100 μm. The spatial frequency component at 3.3 c/mm represents repetitive fluctuation components caused by the lenses 7a, which are arranged at a pitch of 300 μm. The spatial frequency component at 6.6 c/mm represents repetitive fluctuation components caused by the lenses 7a, of which the period has been shortened by the correction coefficients Pn.

It can be seen from FIG. 21 that the fluctuations in amounts of light caused by the lenses 7a are clearly reduced by performing corrections using the correction coefficients Sn and Pn. In addition, when the results of performing correction employing the correction coefficients Sn and the results of performing correction employing the correction coefficients Pn are compared, it can be seen that the spatial frequency components at 3.3 c/mm, which cannot be sufficiently removed by the correction employing the correction coefficients Sn, have been converted to spatial frequency components at 6.6 c/mm, which have shorter periods and are less visually discernable.

Next, FIG. 22 illustrates the results of high speed Fourier transform of image signals, which were read out from a gradation image exposed on the color photosensitive material 3 by causing the linear light emitting element arrays 6R, 6G, and 6B of the exposure apparatus 5 to emit light based on an image data set. In FIG. 22, the broken line, the thin solid line, and the bold solid line represent results of exposure without correction (exposure based on the image data set D), with correction employing the correction coefficients Sn (exposure based on the image data set D′), and with correction employing the correction coefficients Pn (exposure based on the image data set D″), respectively

In this case as well, it can be seen that much of the spatial frequency components at 3.3 c/mm, which cannot be sufficiently removed by the correction employing the correction coefficients Sn, have been converted to spatial frequency components at 6.6 c/mm by correction employing the correction coefficients Pn.

Note that the process for determining the correction coefficients Pn may be performed prior to shipping the exposure apparatus 5 from the factory. The correction coefficients Pn may be correlated with each organic EL light emitting element 20, and recorded in the memory within the control section 31. In this case, image data sets D can be converted to image data sets D″ based on the correction coefficients Pn, during actual use of the exposure apparatus 5. In addition, the light measuring means 50 may be built into the exposure apparatus 5, and determination of correction coefficients Pn may be performed at appropriate intervals after the exposure apparatus 5 is in actual use. The correction coefficients Pn which are recorded in the memory may be replaced by the newly determined correction coefficients Pn. If this is performed, correction coefficients Pn that take into account temporal changes in the light emitting properties of the organic EL light emitting elements can be obtained, thereby enabling more accurate correction.

The image data set D is data that controls the light emission times of the organic EL light emitting elements 20. It is also possible to control the amounts of light emitted by the organic EL light emitting elements 20 by controlling the drive voltage or drive current of the organic EL light emitting elements 20, based on the image data set D. The present invention is also applicable to cases in which this configuration is adopted. In addition, the image data set D may be directly input to the drive circuit 30, instead of the corrected image data set D″. In this case, the drive circuit 30 may correct the light emission times, the drive voltage, or the drive current of the organic EL light emitting elements 20, based on the correction coefficients Pn.

Note that the exposure apparatus 5 of the embodiment described above is that which exposes images onto the color photosensitive material 3, which is a full color positive type silver salt film, employing the linear light emitting element arrays constituted by organic EL light emitting elements. However, the exposure apparatus of the present invention may be configured to expose images on other color photosensitive materials. In addition, the linear light emitting element arrays are not limited to those constituted by organic EL light emitting elements. It is possible to employ linear light emitting element arrays constituted by other types of light emitting elements.

What is claimed is:

1. A method for correcting the amount of light emitted from an exposure head comprising: a linear light emitting element array, constituted by a plurality of light emitting elements which are aligned in a single row, in which the amount of light emitted from each light emitting element is independently controlled based on image signals that bear an image to be exposed; and a lens array, constituted by a plurality of ×1 magnification lenses which are aligned parallel to the row of light emitting elements, for focusing the light emitted from the light emitting elements onto a photosensitive material which is the target of exposure, wherein:
the amount of light emitted from each of the light emitting elements is corrected such that the period of fluctuation in the amount of light, which is a period of the lens arrangement pitch within the lens array, is shortened.

2. A method for correcting the amount of light emitted from an exposure head as defined in claim 1; wherein:
each of the light emitting elements of the linear light emitting element array are caused to emit light uniformly, based on a common light emission command;
the amount of light emitted by the lens array is measured at an optical measuring pitch less than or equal to the lens arrangement pitch across the entire length of the linear light emitting element array;
the amount of light is integrated within sections which are equal to the lens arrangement pitch at each boundary between two adjacent light emitting elements;
a correction coefficient is derived for each light emitting element, based on the integrated amount of light derived for at least the two boundaries at both sides of the light emitting element; and
the amounts of light, which are controlled based on the image signals, are corrected for each light emitting element based on the correction coefficient therefor, when exposing the photosensitive material.

3. A method for correcting the amount of light emitted from an exposure head as defined in claim 2, wherein:
n/n+1 denotes the boundary between an nth light emitting element and an (n+1) th light emitting element;
L(n/n+1) denotes the integrated amount of light at the boundary (n/n+1);
an average value L0 of the integrated amount of light for all of the boundaries is calculated;
a correction coefficient for the boundary n/n+1 is calculated as K(n/n+1)=1−L(n/n+1)/L0; and
the correction coefficient Pn for an n^{th} light emitting element is calculated based on the formula:
Pn=1−Q{−K(n−2/n−1)+K(n−1/n)+K(n/n+1)−K(n+1/n+2)}.

4. A method for correcting the amount of light emitted from an exposure head as defined in claim 2, wherein:
the integrated amount of light is obtained for each light emitting element by totaling amounts of light, measured at a plurality of measurement points along the direction that the light emitting elements are arranged, then dividing the total amount by the number of measurement points.

5. A method for correcting the amount of light emitted from an exposure head as defined in claim 1, wherein:
the amounts of light emitted from each of the light emitting elements are corrected to be uniform, prior to correcting the amounts of light such that the period of fluctuation in the amount of light, which is a period of the lens arrangement pitch within the lens array, is shortened.

6. A method for correcting the amount of light emitted from an exposure head as defined in claim 1, wherein:
the amount of light emitted from each of the light emitting elements is controlled by adjusting the emission times thereof.

7. A method for correcting the amount of light emitted from an exposure head as defined in claim 1, wherein:
the amount of light emitted from each of the light emitting elements is controlled by adjusting one of the drive voltage and the drive current.

8. A method for correcting the amount of light emitted from an exposure head as defined in claim 1, wherein:
processes for calculating the correction coefficients of the light emitting elements are successively performed at predetermined temporal intervals during actual use of the exposure head; and
the correction coefficients which are employed to perform correction are changed to new correction coefficients, each time that new correction coefficients are calculated.

9. A method for correcting the amount of light emitted from an exposure head as defined in claim 1, wherein:
the amount of light emitted through the lens array is measured by a single photoreceptor that moves intermittently along the arrangement direction of the light emitting elements.

10. A method for correcting the amount of light emitted from an exposure head as defined in claim 1, wherein:
the amount of light emitted through the lens array is measured by a photoreceptor array, in which photoreceiving elements are arranged in the arrangement direction of the light emitting elements.

11. An exposure apparatus that implements the method for correcting the amount of light emitted from an exposure head as defined in claim 1, comprising:
an exposure head, comprising a linear light emitting element array, constituted by a plurality of light emitting elements which are aligned in a single row, in which the amount of light emitted from each light emitting element is independently controlled based on image signals that bear an image to be exposed; and a lens array, constituted by a plurality of ×1 magnification lenses which are aligned parallel to the row of light emitting elements, for focusing the light emitted from the light emitting elements onto a photosensitive material which is the target of exposure;
sub scanning means, for moving the exposure head and the photosensitive material relative to each other in a direction perpendicular to the arrangement direction of the light emitting elements;
memory means, for recording correction coefficients for correcting the amount of light emitted from each of the light emitting elements such that the period of fluctuation in the amount of light, which is a period of the lens arrangement pitch within the lens array, is shortened therein; and
correction means, for correcting the amounts of light emitted from the light emitting elements, which are controlled based on the image signals, based on the correction coefficients, which are read out from the memory means.

12. An exposure apparatus as defined in claim 11, wherein:
the light emitting elements are auto light emitting elements.

13. An exposure apparatus as defined in claim 11, wherein:
the light emitting elements are organic EL light emitting elements.

14. An exposure apparatus as defined in claim 11, wherein:
the light emitting elements are combinations of light sources and light modulating elements.

15. An exposure apparatus as defined in claim 1, wherein:
a plurality of the linear light emitting element arrays are provided, arranged in a direction substantially perpendicular to the arrangement direction of the light emitting elements.

16. An exposure apparatus as defined in claim 15, wherein:
the plurality of the linear light emitting element arrays emit red, blue, and green light, to enable exposure of full color images on the photosensitive material.
